(19) United States
(12) Patent Application Publication
(10) Pub. No.: US 2026/0139785 A1
(43) Pub. Date: May 21, 2026

(54) HYDRAULIC HOSE REPAIR SYSTEM AND METHOD

(71) Applicant: James Marlon Wild, Springfield, LA (US)

(72) Inventor: James Marlon Wild, Springfield, LA (US)

(21) Appl. No.: 18/949,651

(22) Filed: Nov. 15, 2024

(51) Int. Cl. F16L 55/16

(52) U.S. Cl. CPC F16L 55/1608

(57) ABSTRACT

A hydraulic hose repair system and method for the removal and replacement of a hydraulic line mounted within a structure such as the articulated boom and arm of an excavator. The hydraulic hose repair system provides a pull connector unit which in turn provides a hose adapter having a mounting stud, a mounting receiver to receive the mounting stud, a connector body surrounded by a spring, and a tapered end. A pull line is mounted to the pull connector unit at the tapered end using a free-turning linkage which provides for unlimited turning or spinning in either direction, thereby avoiding any buildup of torsion or twisting forces or stress. The damaged hydraulic hose is disconnected at both ends and a pull connector unit with an attached pull line is securely and removably mounted to one end of the damaged hydraulic hose. The damaged hydraulic hose is then pulled from the other end to remove the damaged hose, and the pull line connected to the pull connector unit is pulled into the path or space vacated by the damaged hydraulic hose. The pull line and pull connector unit are subsequently used to pull a new hydraulic hose or the repaired hose back along the path and back into position for re-connection. In an optional embodiment, an indicator unit and a battery are also provided within the connector body.

### BACKGROUND OF THE INVENTION

This invention provides a hydraulic hose repair system and method for the removal and replacement of a hydraulic line mounted within a structure such as the articulated boom and arm of an excavator.

Excavators, backhoes, power shovels, and similar heavy construction equipment operate using several hydraulic cylinders and motors which in turn use pressurized hydraulic fluid which is controlled by several valves and which is conveyed to the different hydraulic cylinders and motors through separate hydraulic lines made either of metal or of very strong rubber or similar material. The hydraulic lines are usually run inside of an articulated boom, arm, or similar articulated structure. Because the path of the hydraulic lines includes moving and bending sections, a bendable material such as rubber tubing serves as a better hydraulic line. The hydraulic lines are subject to wear and damage and failure, which often occurs on the jobsite and which often interrupts operations, which necessitate the removal and replacement of damaged hydraulic lines on the jobsite and under time pressure. Under such circumstances it is very difficult to remove and then replace an entire run of hydraulic line through the articulated structures where there is limited opportunity to remove several different access panels or otherwise partially disassemble the equipment. The damaged hydraulic line tends to get bound and stuck when being pulled out, and the new hydraulic line is very difficult to push into place along a complex path.

What is needed is a hydraulic hose repair system and method providing for removal and re-installation of hydraulic lines.

U.S. Pat. No. 9,802,785 for “Systems and Methods for Facilitating Wire and Cable Installations,” issued on Oct. 31, 2017 to assignee Southwire Company, LLC, provides for systems and methods for facilitating wire and cable installations. According to embodiments, a system comprises a reel and a first parallel including a first conductor loaded onto the reel in a first layer. The system may further comprise a second parallel including a second conductor loaded onto the reel in a second layer. At least a portion of the second layer of the second parallel may be loaded on top of at least a portion of the first layer of the first parallel.

U.S. Pat. No. 3,567,268 for a “Flexible Conduit Pulling Means,” issued on Mar. 2, 1971 to inventor Donald E. Peterson, provides for a body having a cylindrical portion with outside threads thereon adapted to threadedly engage a flexible conduit, a shroud or conical portion for protecting the end of the conduit from catching and for directing the end of the conduit into and through the various openings, and an eye at one end adapted to receive ae flexible cord therethrough for pulling the conduit.

U.S. Pat. No. 5,067,843 for a “Pulling Attachment for Flexible Conduit,” issued on Nov. 26, 1991 to inventor Wallace B. Nova, provides for a tool for attaching a pulling cable to flexible metal conduit having a convolute inner wall surface, and the tool has a generally cylindrically shaped rear body section having a raised helical rib adapted to threadingly engage the helical inner wall convolutions of a length of conduit. The front body section of the tool has a tapered, bullet-shape tip with a flat front face. A longitudinal disposed slot extending rearward from the front face of the tip is adapted to receive the grommeted end of a fish tape leader or similar pulling cable. Axially aligned holes extending transversely through the two laterally spaced apart from jaw members formed by the slot are provided to receive a securing member such as a screw which passes through the grommet, thereby securing the cable to the tool.

U.S. Pat. No. 4,123,133 for a “Method and Apparatus for Applying a Connector to Electrical Conductor Strands,” issued on Oct. 31, 1978 to inventors Wiley J. Pickett et al., provides for a connector for making connection to an end of an electrical conductor cable to be pulled through conduits or the like, and the connector comprises a centrally-bored inner connector member having a conical outer surface wedged into a correspondingly conical recess in an outer connector member, with an outer portion of the end of the conductor cable grasped between the two conical surfaces and an inner portion of the cable end gripped within the central bore of the inner connector member. The inner conical member is made of a material which is highly malleable with respect to the inner surface of the outer connector member and at least as malleable as the material of the cable, and sufficient wedging force is provided between the inner and outer connector members so that both the inner and outer portions of the conductor cable become embedded to a substantial extent in the material of the inner connector member. This embedding enhances the strength with which the inner and outer connector members grasp the inner and outer cable portions. The wedging action may be provided by the normal forces used to pull the cable. A preferred material for the inner connector member is aluminum of a purity of at least 80% and preferably greater than 95%, with an elongation of at least 20% and preferably greater than 30%, and a Brinell hardness number no greater than 40 and preferably less than 25.

U.S. Pat. No. 11,293,519 for a “Lanyard Assembly for Wire-Pulling or Wire-Anchoring Purposes,” issued on Apr. 5, 2022 to assignee iTool Equipment Holding LLC, provides for a wire-anchoring system for use with a core about which a wire is desired to be wound, and the system utilizes a lanyard assembly which includes a cord portion and a connector body connected to the cord portion. The elongated connector body has two opposite ends and a hollow interior including an opening which opens out of the body at one end thereof and into which the terminal end of the wire can be inserted for purposes of anchoring the wire to the connector body. In addition, the cord portion of the wire has a free end which is securable to the outer surface of the core adjacent the securement location thereon so that by securing the free end of the cord portion to the outer surface of the core and anchoring the terminal end of the wire to the connector body, the wire is anchored to the core for an operation involving the winding of the wire about the core.

U.S. Pat. No. 7,216,846 for an “Apparatus and Methods for Disposing Conduits, Wires, and the Like Through Structures,” issued on May 15, 2007 to inventor James Ernest Crawford, provides for a connection apparatus and associated method. The connection apparatus is configured to be connected to a guide line and a conduit so that the conduit can be pulled through a structure by the guide line. In this regard, the apparatus can include a body member that extends between first and second ends and defines a connector for engaging the guide line and an engagement portion for engaging the conduit. In some cases, a second connector is provided to engage a cable, such as an electrical wire, that is disposed in the conduit. Thus, the apparatus can be used to pull the conduit by a leading end thereof, and the apparatus can additionally pull the cable through the structure with the conduit, i.e., without requiring separate operations. The body member can also define a tapered outer contour, such as a frustoconical shaped end, to facilitate the passage of the apparatus and conduit through the structure.

US Publication No. 2008/0017837 for a “Screw-in Conduit Puller,” published on Jan. 24, 2008 by inventor Vincent Christopher Steele, discloses a device for the installation of electrical conduit. It consists of an adaptor portion that interfaces with and connects to electrical conduit. On the opposite end of the device lies an appendage to which a guiding line can attach. A handle portion permits easy manipulation for both screwing and unscrewing of the adaptor and a flange portion prevents excessive and unnecessary screwing.

### SUMMARY OF THE INVENTION

A hydraulic hose repair system and method for the removal and replacement of a hydraulic line mounted within a structure such as the articulated boom and arm of an excavator. The hydraulic hose repair system provides a pull connector unit which in turn provides a hose adapter having a mounting stud, a mounting receiver to receive the mounting stud, a connector body surrounded by a spring, and a tapered end. A pull line is mounted to the pull connector unit at the tapered end using a free-turning linkage which provides for unlimited turning or spinning in either direction, thereby avoiding any buildup of torsion or twisting forces or stress. The damaged hydraulic hose is disconnected at both ends and a pull connector unit with an attached pull line is securely and removably mounted to one end of the damaged hydraulic hose. The damaged hydraulic hose is then pulled from the other end to remove the damaged hose, and the pull line connected to the pull connector unit is pulled into the path or space vacated by the damaged hydraulic hose. The pull line and pull connector unit are subsequently used to pull a new hydraulic hose or the repaired hose back along the path and back into position for re-connection. In an optional embodiment, an indicator unit and a battery are also provided within the connector body.

### BRIEF DESCRIPTION OF THE DRAWINGS

Reference will now be made to the drawings, wherein like parts are designated by like numerals, and wherein:

FIG. 1 is a side view of the hydraulic hose repair system of the invention;

FIG. 2 is a side cutaway view of the hydraulic hose repair system of the invention;

FIG. 3 is an exploded view of the hydraulic hose repair system of the invention;

FIG. 4 is a schematic view of the hydraulic hose repair system of the invention in use on an excavator during an initial phase of use;

FIG. 5 is a schematic view of the hydraulic hose repair system of the invention in use on an excavator during an intermediate phase of use; and

FIG. 6 is a schematic view of the hydraulic hose repair system of the invention in use on an excavator during a final phase of use.

### DETAILED DESCRIPTION OF THE INVENTION

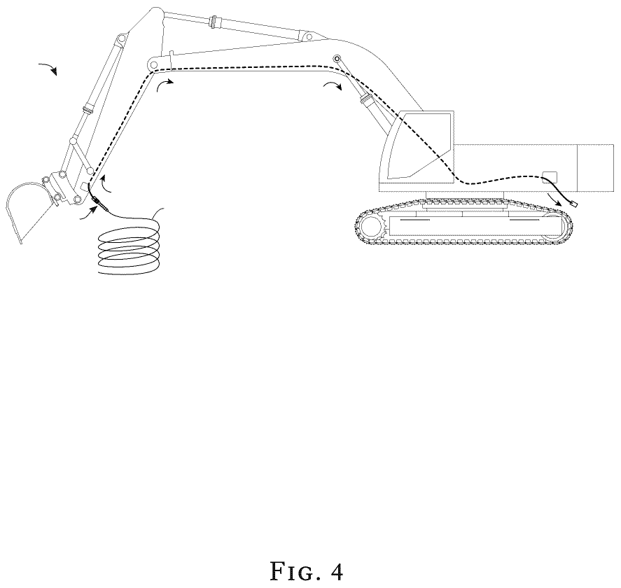

Referring initially to FIG. 4, the hydraulic hose repair system 10 and method of the invention provide for the removal and replacement of a hydraulic line mounted within a structure such as the articulated boom and arm of an excavator as illustrated. The damaged hydraulic hose is disconnected at both ends. The pull connector unit 1 is securely and removably mounted to one end of the damaged hydraulic hose. The damaged hydraulic hose is then pulled from the other end to remove the damaged hose. The pull line 9 connected to the pull connector unit 1 is pulled into the path or space vacated by the damaged hydraulic hose, and is subsequently used to pull a new hydraulic hose or the repaired hose back along the path and back into position for re-connection. The pull connector unit 1, when removably mounted to the end of the damaged or the new hydraulic hose, assists in the removal and reinstallation of the hose by avoiding becoming stuck itself and by positioning and holding the end of the hydraulic hose in such a way as to avoid becoming stuck.

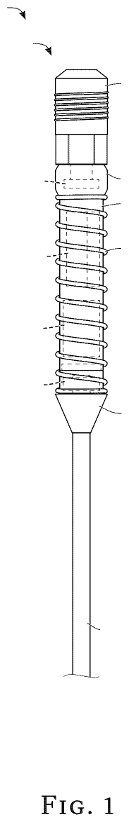

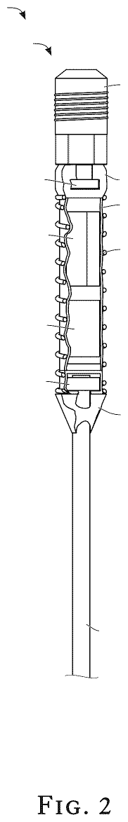

Referring to FIG. 1 and FIG. 2, the hydraulic hose repair system 10 provides a pull connector unit 1 which in turn provides a hose adapter 2 having a mounting stud 3, a mounting receiver 4 to receive the mounting stud 3, a connector body 5 surrounded by a spring 6, and a tapered end 7. A pull line 9 is mounted to the pull connector unit 1 at the tapered end 7 using a free-turning linkage 8 which provides for unlimited turning or spinning in either direction, thereby avoiding any buildup of torsion or twisting forces or stress. The pull connector unit 1 has an axial orientation with the hose adapter 2 and mounting receiver 4 at a hose end, and the tapered end 7 at a line end, with the connector body 5 and spring 6 between the mounting receiver 4 and the tapered end 7. When the pull line 9 and pull connector unit 1 are being pulled back through the structure with a new hydraulic hose, the tapered end 7 becomes the leading end, and the taper avoids becoming stuck on obstructions. In an optional embodiment, an indicator unit 11 and a battery 12 are also provided within the connector body 5, as treated in detail below.

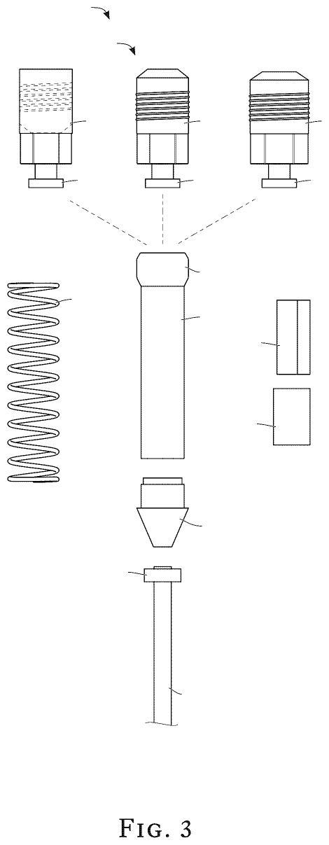

Referring additionally to FIG. 3, more than one configuration of the hose adapter 2 is provided, each configured to fit and be removably mounted to a specific style and size of hydraulic-hose connector, and each configured, for example, as a plug or socket as needed. Each hose adapter 2 provides a mounting stud 3, and the various configurations of the hose adapter 2 can be interchangeably mounted to the mounting receiver 4. In a preferred embodiment, the mounting stud 3 is allowed to spin or turn axially within the mounting receiver 4 in order to avoid torsion or twisting forces, as with the free-turning linkage 8 and pull line 9, and additionally to avoid loosening or over-tightening the connection of the hose adapter 2 to the hydraulic hose end fitting.

The hose adapters 2 can be made of metal or of a hard plastic or composite material. The hose adapters 2 should not have any protruding parts or any parts or features which can interfere with the smooth movement of the pull connector unit 1 in either direction. The mounting receiver 4 and the tapered end 7 can also be made of metal or of a hard plastic or composite material. The connector body 5 is made to be strong and stiff but somewhat flexible to allow for slight bending of the connector body 5 when the pull connector unit 1 is pulled around a bend or obstruction. A section of hydraulic hose tubing or a similar material can be used as the connector body 5. The spring 6 provides some protection and support to the connector body 5, and also allows for slight bending when pulled around bends or obstructions, with a return to a straight unbent axial orientation after the bend or obstruction is cleared.

The pull line 9 can be made from a rope, line, or cable having sufficient strength and stability to withstand the pulling forces exerted in use, and having sufficient flexibility to operate without coiling, kinking, bunching, or otherwise causing obstacles or resistance. The pull line 9 is mounted to the pull connector unit 1 using a free-turning linkage 8 which allows unlimited turning or spinning in either direction. Any buildup of torsion or twisting forces or stress in the pull line 9 would tend to cause the pull line 9 to stiffen, coil, kink, or bunch, which would interfere with operation of the pull connector unit 1. If, in use, it is necessary to twist or spin the damaged hydraulic hose while removing it, it would be detrimental to transmit the torsion to the pull line 9, and the free-turning linkage 8 avoids such transmission of torsion. In a preferred embodiment the pull line 9 is marked with distance measurements which indicate how far the pull connector unit 1 has been pulled into the boom or other pathway in one direction, or how close the end of the new hose is approaching in the other direction.

In an optional embodiment referenced above, an indicator unit 11 and battery 12 are also provided. The indicator unit provides a real-time indication of where within the boom, arm, or structure the pull connector unit 1 with the attached hydraulic hose end is located. The indication can be made in a variety of ways or combinations. The indicator unit 11 might emit a light, which would likely only be useful if some kind of mirror or video scope to see inside the boom is also used. A sound emission might be useful in order to at least approximate location. A vibration, buzzing, rattling, or tapping might be transmitted through the boom structure and be more precisely located from outside. The indicator unit 11 provides one or more types of indication of location. The battery 12 provides power for operation of the indicator unit 11.

Referring to FIG. 4, in an initial phase of use the damaged hydraulic hose is disconnected at both ends, and the pull connector unit 1 is securely and removably mounted to one end of the damaged hydraulic hose.

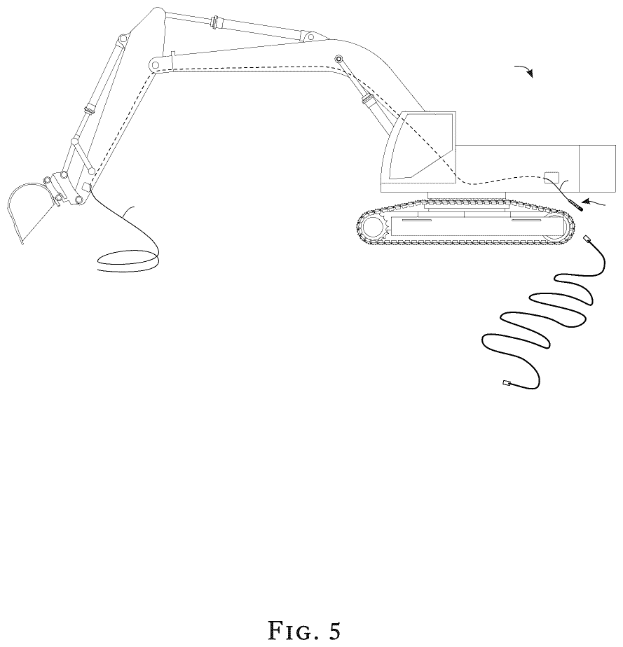

Referring to FIG. 5, in an intermediate phase of use the damaged hydraulic hose is then pulled from the other end to remove the damaged hose. The pull line 9 connected to the pull connector unit 1 is pulled into the path or space vacated by the damaged hydraulic hose. The damaged hydraulic hose is removed from the pull connector unit 1.

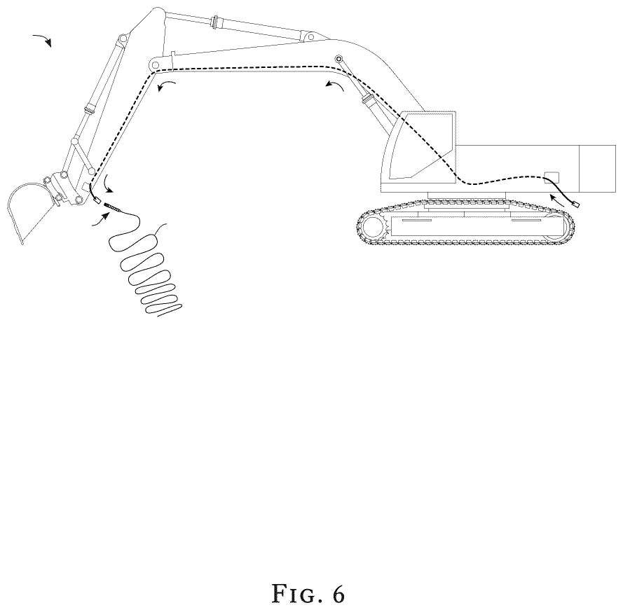

Referring to FIG. 6, in a final phase of use an end of a new or repaired hydraulic hose is securely and removably mounted to the pull connector unit 1 and the new or repaired hose is pulled back along the path and back into position for re-connection after the pull connector unit 1 is removed.

Many other changes and modifications can be made in the system and method of the present invention without departing from the spirit thereof. I therefore pray that my rights to the present invention be limited only by the scope of the appended claims.

I claim:

1. A hydraulic hose repair system comprising:
(i) a pull connector unit having an axial orientation, comprising:
(a) at least one hose adapter having a mounting stud and adapted to be removably mounted to an end of a hydraulic hose in use;
(b) a mounting receiver adapted for interchangeably mounting said mounting stud of said hose adapter;
(c) a connector body connected to said mounting receiver;
(d) a spring surrounding said connector body; and
(e) a tapered end connected to said connector body; and
(ii) a pull line connected to said pull connector unit at said tapered end through a free-turning linkage.

2. The hydraulic hose repair system of claim 1, further comprising an indicator unit and a battery.

3. The hydraulic hose repair system of claim 1, where said mounting stud and said mounting receiver are further adapted to allow free axial spinning.

4. A hydraulic hose repair system for removal and replacement of a hydraulic line mounted within a structure, the hydraulic hose repair system comprising:
(i) a pull connector unit having an axial orientation, comprising:
(a) at least one hose adapter having a mounting stud and adapted to be removably mounted to an end of the hydraulic hose in use;
(b) a mounting receiver adapted for interchangeably mounting said mounting stud of said hose adapter;
(c) a connector body connected to said mounting receiver;
(d) a spring surrounding said connector body; and
(e) a tapered end connected to said connector body; and
(ii) a pull line connected to said pull connector unit at said tapered end through a free-turning linkage.

5. The hydraulic hose repair system of claim 4, further comprising an indicator unit and a battery.

6. The hydraulic hose repair system of claim 4, where said mounting stud and said mounting receiver are further adapted to allow free axial spinning.

7. A hydraulic hose repair method comprising:
(i) providing a hydraulic hose repair system comprising:
(a) a pull connector unit having an axial orientation, comprising:
(1) at least one hose adapter having a mounting stud and adapted to be removably mounted to an end of the hydraulic hose in use;
(2) a mounting receiver adapted for interchangeably mounting said mounting stud of said hose adapter;
(3) a connector body connected to said mounting receiver;
(4) a spring surrounding said connector body; and
(5) a tapered end connected to said connector body; and
(b) a pull line connected to said pull connector unit at said tapered end through a free-turning linkage;
(ii) disconnecting the damaged hydraulic hose at both ends;
(iii) mounting said pull connector unit to an end of the damaged hydraulic hose;
(iv) pulling from the other end of the damaged hydraulic hose to remove the hose and to pull said pull connector unit with said pull line into the path vacated by the hydraulic hose;
(v) unmounting said pull connector unit from the end of the damaged hydraulic hose;
(vi) mounting an end of a new or repaired hydraulic hose to said pull connector unit;
(vii) pulling said pull line to pull said pull connector unit and the new or repaired hydraulic hose into place;
(viii) unmounting said pull connector unit from the end of the new or repaired hydraulic hose; and
(ix) re-connecting the new or repaired hydraulic hose at both ends.
